(19) United States
(12) Patent Application Publication
(10) Pub. No.: US 2004/0010779 A1
(43) Pub. Date: Jan. 15, 2004

(54) Multi-module interpreter

(76) Inventor: Michael A. Di Loreto, Tres Pinos, CA (US)

Correspondence Address: HEWLETT-PACKARD COMPANY, Intellectual Property Administration, P.O. Box 272400, Fort Collins, CO, 80527-2400, US

(21) Appl. No.: 10/192,600

(22) Filed: Jul. 10, 2002

(51) Int. Cl. G06F 9/45; G06F 9/44

(52) U.S. Cl. 717/139; 717/118; 717/116; 717/148

(57) ABSTRACT

A multi-module interpreter comprises a first module configured to provide execution functions for executing a computer method, a second module, logically coupled to said first module, configured to execute the computer method, and an interface configured to facilitate transfer of control among the first and second modules. The multi-module interpreter is advantageous because it provides execution functions for executing compiled native machine code without necessarily requiring such functions to be encoded into the machine code.

### BACKGROUND

Computer programs are typically written in human readable computer code (e.g., source code). The source code generally has to be compiled into native machine code to be executable via native hardware at a computer platform. Compilation is a process of translating computer code from one format (e.g., source code) to another format (e.g., native machine code).

Computer programs written in certain two-stage programming languages, such as the Java programming language, are typically compiled from source code into intermediate code (i.e., Java byte code instructions). The intermediate code may be directly executed by an interpreter, and/or compiled into native machine code via a second compiler and then executed. Typically, in the latter case, the compiled native machine code may also be stored in memory for future reuse if the computer program is called again.

The foregoing interpretation and execution of intermediate code and/or compilation of intermediate code into native machine code is performed via a so-called “virtual processor.” The virtual processor is typically software installed on a computer platform, but may also be implemented in hardware or a combination of software and hardware. Intermediate code is generally platform independent and may be portable to multiple computer platforms having a compatible virtual processor.

A virtual processor for the Java programming language is generally referred to as the Java Virtual Machine (JVM) (e.g., a commercially available package called the Java Development Kit (JDK) 1.X provided by Sun Microsystems, Inc.). Typically, the JVM comprises several modules, namely, a Java compiler, a Java interpreter, and/or a Just-In-Time compiler (JIT). Alternatively, the Java compiler may be a separate module from the JVM. Technical specifications for implementing a JVM are well known to those skilled in the art and need not be described in detail here. See for example, T. Lindholm and F. Yellin, “The Java Virtual Machine Specification,” Addison Wesley, 1999, second edition, which is hereby incorporated by reference for all purposes.

The Java compiler, whether or not a part of the JVM, generally functions to compile Java source code into Java byte code instructions. The Java interpreter generally functions to interpret and execute the byte code instructions. The JIT generally functions to compile the byte code instructions into native machine code, such that native hardware at a computer platform may execute the native machine code.

Generally, the first time a compiled Java program (or a so-called Java method) is invoked, its byte code instructions are either interpreted and executed by the Java interpreter during runtime, or compiled into native machine code by the JIT. In the latter case, the native machine code may be executed via native hardware of the computer platform. The native machine code may also be stored in memory. Thus, the next time the same method is invoked, its native machine code may be retrieved directly from memory and executed.

Typically, the time from which a Java method is invoked to the execution of the method is shorter if the associated byte code instructions have already been translated into native machine code and stored in memory. Thus, the JIT may be preferred for programs that are likely to be reused, when faster execution is desired, and when memory resources for storage of the translated native machine code are available.

During execution of a method, the JVM can support the execution by providing functions that are not explicitly expressed in the byte code instructions of the method. These functions include invoking and/or executing method(s) that have been invoked by a method being executed, initializing classes that have been called by a method being executed, handling exceptions thrown by a method being executed, maintaining multi-threading functions, and/or other functions. Technical specifications for these functions are well known to those skilled in the art and need not be described in detail here; see, for example, “The Java Virtual Machine Specification.”

Generally, when a method's byte code instructions are executed by an interpreter, the interpreter provides the execution functions. However, when byte code instructions have been compiled to native machine code (e.g., by a JIT), the interpreter no longer has control of the execution environment. Thus, execution functions either have to be encoded into the native machine code or implemented by a module other than the interpreter.

The former generally renders the native machine code extremely difficult to compile. In the latter, the module that provides execution functions is responsible for providing functions, such as calling the interpreter each time the native machine code being executed calls another method. This module typically involves a recursive control structure. Thus, if multiple methods are called in a method being executed or if each called method calls one or more other methods, the interpreter would be recursively called numerous times. As multiple recursive calls are being made to the interpreter and/or other modules (e.g., for handling exceptions, etc.), some recursive control structures may become prohibitively complex and prone to failure. Further, some recursive control structures may grow to require a large amount of memory resources.

Thus, a market exists for an interpreter that is capable of providing execution functions for executing a method that has already been compiled to native machine code. Of course, various embodiments described herein do not strictly exclude the use of a recursive control structure, but merely eliminate the necessity of using the recursive control structure.

### SUMMARY

A multi-module interpreter comprises a first module configured to provide execution functions for executing a computer method obtained via an input interface, a second module logically coupled to the first module and configured to execute the computer method, an interface configured to facilitate transfer of control among the first and second modules, and an output interface configured to output a result of the executed computer method. In an exemplary embodiment, the second module is further configured to execute the computer method until a control transfer event occurs, generate an instruction indicating the control transfer event, and transfer control and the instruction to the first module for processing the control transfer event.

### BRIEF DESCRIPTION OF THE FIGURES

FIG. 1 illustrates a block diagram of an exemplary operating environment.

FIG. 2 illustrates a block diagram of an exemplary multi-module interpreter.

FIG. 3 illustrates a flow chart of an exemplary process of the control flow in an exemplary multi-module interpreter.

### DETAILED DESCRIPTION

I. Overview

An exemplary multi-module interpreter comprises a module for providing execution functions for executing a method and another module for executing the method. Section II describes an exemplary operating environment in connection with which a multi-module interpreter may be used, Section III describes an exemplary embodiment of a multi-module interpreter, Section IV describes an exemplary control flow in the multi-module interpreter, and Section V describes miscellaneous aspects of the multi-module interpreter.

II. An Exemplary Operating Environment

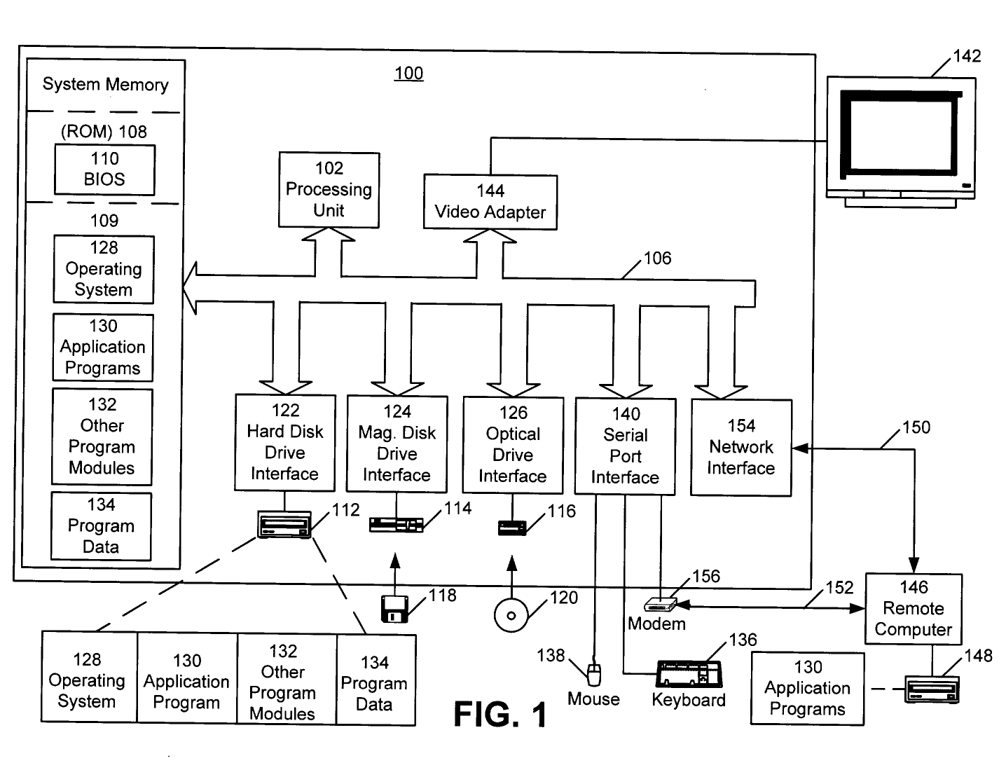

FIG. 1 is a block diagram of an exemplary operating environment. The description of FIG. 1 is intended to provide a brief, general description of one common type of computer hardware and computing environment in conjunction with which the various exemplary embodiments described herein may be implemented. Of course, other types of operating environments may be used as well.

Moreover, those skilled in the art will appreciate that other computer system configurations, including hand-held devices, multiprocessor systems, microprocessor-based or programmable consumer electronics, network PCs, minicomputers, mainframe computers, and the like may be implemented. Further, various embodiments described herein may also be practiced in distributed computing environments where tasks are performed by remote processing devices that are linked through a communications network. In a distributed computing environment, program modules may be located in both local and remote memory storage devices. Generally, the terms program, code, module, software, and other related terms as used herein may include routines, programs, objects, components, data structures, etc., that perform particular tasks or implement particular abstract data types.

The exemplary hardware and operating environment of FIG. 1 includes a general purpose computing device in the form of a computer 100. The computer includes a processing unit 102, a system memory 104, and a system bus 106 that operatively couples various system components, including the system memory 104, to the processing unit 102. There may be one or more processing units 102, such that the processor of computer 100 comprises a single central-processing unit (CPU), or a plurality of processing units, commonly referred to as a parallel processing environment. The computer 100 may be a conventional computer, a distributed computer, or any other type of computing device.

The system bus 106 may be any of several types of bus structures, including a memory bus or memory controller, a peripheral bus, a local bus using any of a variety of bus architectures, etc. The system memory 104 may also be referred to as simply the memory, and may include read only memory (ROM) 108, random access memory (RAM) 109, and/or other types of memory. In an exemplary embodiment, a basic input/output system (BIOS) 110, containing the basic routines that help to transfer information between elements within the computer 100, such as basic routines during start-up, may be stored in the ROM 108.

The computer 100 further includes a hard disk drive 112 for reading from and writing to a hard disk (not shown), a magnetic disk drive 114 for reading from or writing to a removable magnetic disk 118, an optical disk drive 116 for reading from or writing to a removable optical disk 120 (e.g., a CD ROM), and/or other disk and media types. The hard disk drive 112, magnetic disk drive 114, and optical disk drive 116 may be connected to the system bus 106 by a hard disk drive interface 122, a magnetic disk drive interface 124, and/or an optical disk drive interface 126, respectively. The drives and their associated computer-readable media may provide nonvolatile storage of computer-readable instructions, data structures, program modules and other data for the computer 100. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 118, optical disk 120, ROM 108, and/or RAM 109. Exemplary program modules include an operating system 128, one or more application programs 130, other program modules 132, and/or program data 134.

A user may enter commands and information into the computer 100 through input devices such as a keyboard 136 and/or a pointing device 138. Other input devices (not shown) may include a microphone, joystick, game pad, satellite dish, scanner, and/or other devices. Input devices are often connected to the processing unit 102 through a serial port interface 140 that is coupled to the system bus 106. Alternatively, input devices may be connected by other interfaces, such as a parallel port, game port, a universal serial bus (USB), etc. A monitor 142 or other type of display device may also be connected to the system bus 106 via an interface, such as a video adapter 144. Alternatively, or in addition to the monitor 142, computer 100 may include other peripheral output devices, such as speakers and printers (not shown).

The computer 100 may operate in a networked environment using logical connections to one or more remote computers, such as remote computer 146. These logical connections may be achieved by a communication device coupled to a part of the computer 100. The remote computer 146 may be another computer, a server, a router, a network PC, a client, a peer device, and/or other common network node, and may include some or all of the elements described above in relation to the computer 100. The exemplary logical connections depicted in FIG. 1 include a local-area network (LAN) 150 and/or a wide-area network (WAN) 152. Such networking environments are commonplace in offices, enterprise-wide computer networks, intranets and the Internet.

When used in a LAN-networking environment, the computer 100 may be connected to the local network 150 through a network interface or adapter 1156, which is a type of communications device. When used in a WAN-networking environment, the computer 100 may include a modem 156, and/or any other type of communications device for establishing communications over the wide area network 152, such as the Internet. In an exemplary embodiment, the modem 156, which may be internal or external, is connected to the system bus 106 via the serial port interface 140. In a networked environment, program modules depicted relative to the personal computer 100, or portions thereof, may be stored in the remote memory storage device 148. It is appreciated that the network configuration shown is merely exemplary, and that other technologies for establishing a communications link between the computers may also be used.

III. An Exemplary Multi-Module Interpreter

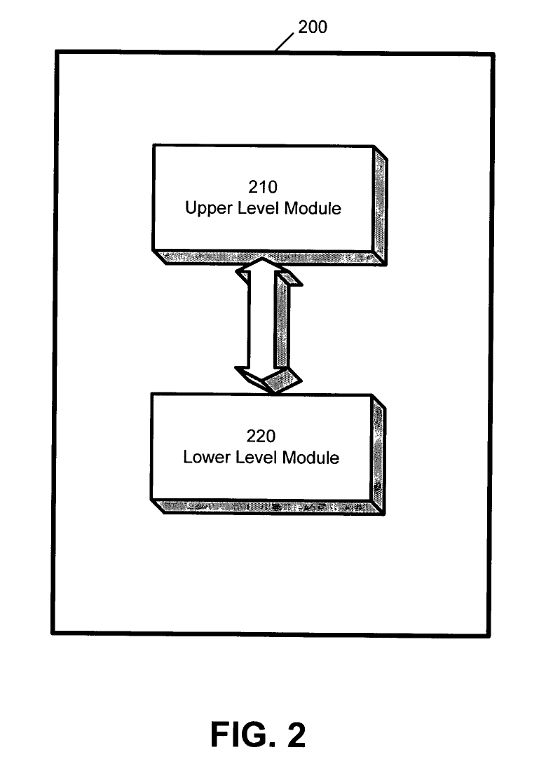

FIG. 2 illustrates an exemplary multi-module interpreter 200. This multi-module interpreter 200 has two modules, namely, an upper level module 210 and a lower level module 220. Of course, the separation of an interpreter into two modules is merely exemplary. Those skilled in the art will appreciate that more than two modules may also be implemented according to the requirements of a particular implementation. Further, throughout this and other sections, references to “upper” and “lower” are merely exemplary, rather than denoting any required order or hierarchy.

A. Exemplary Functions for the Upper Level Module

In an exemplary embodiment, the upper level module 210 sets up an execution environment and provides execution functions for executing one or more methods. For example, the upper level module 210 may set up an execution environment by initializing objects and variables into memory space for use by the invoked method, and/or perform other known functions for setting up an execution environment according to the needs of a particular implementation. The execution functions may include, without limitation, invoking and returning from methods, initializing classes, handling exceptions, maintaining multi-threading functions, and/or other functions. These other functions may further include, without limitation, any function that cannot be and/or is inconvenient to be performed by the lower level module 220. These functions may be implemented singly or in various combinations, using a multi-module interpreter.

1. Invoking and Returning from Methods

A method being executed may call another method. For example, during execution of a first method (e.g., by the lower level module 220), if the first method calls a second method, control would be transferred to the upper level module 210, which would invoke the second method. Further, if necessary, the upper level module 210 would transfer control to the lower level module 220 to execute the second method. When the lower level module 220 completes the execution of the second method, control would again be transferred to the upper level module 210. The upper level module 210 then would determine whether and/or where the execution of the first method should resume. If the execution of the first method should resume, the upper level module 210 would transfer control to the lower level module 220 to resume execution of the first method at the appropriate instruction location.

Of course, the situation described above is merely exemplary. Those skilled in the art will appreciate that multiple methods may be called by a method being executed. Further, a method being called by another method may itself call other method(s). Thus, various implementations of the upper level module 210 may be used according to the requirements of a particular operational implementation.

2. Initializing Classes

A class typically includes variables and/or methods. A method being executed may access a class. For example, during execution of a first method by the lower level module 220, if the first method calls a second method that is within a class that has not been initialized, control would be transferred from the lower level module 220 to the upper level module 210. The upper level module 210 would initialize the class that has not been initialized, typically, by invoking a class initialization method. Further, initialization of the class may require synchronization functions, since some other thread(s) may be trying to initialize the same class at the same time. There is also the possibility that initialization of a class may be requested recursively as part of the initialization of that class. The upper level module 210 is responsible for invoking the class initialization method, synchronization, recursive initialization, and/or other functions as part of initialization of a class.

For example, the upper level module 210 may transfer control to the lower level module to execute the class initialization method. When the lower level module 220 completes the execution of the class initialization method, control would again be transferred to the upper level module 210. The upper level module 210 then would determine whether and/or where the execution of the first method should resume. If the execution of the first method should resume, the upper level module 210 would transfer control to the lower level module 220 to resume execution of the first method at the appropriate instruction location. Further, the upper level module 210 would perform synchronization functions to coordinate access among multiple threads and/or maintain recursive initialization, if necessary. Synchronization functions will be described in more detail in Section III.A.4 below.

The situation described above is merely exemplary. Those skilled in the art will appreciate that multiple classes may be accessed by a method being executed. Further, a class being accessed by a method may itself call other method(s) and/or access other class(es). Thus, various implementations of the upper level module 210 may be used according to the requirements of a particular operational implementation.

3. Handling Exceptions

The Java programming language specifies that an exception is thrown when semantic constraints are violated. Such violation(s) will cause a non-local transfer of control from the point where the exception occurred to a point specifiable by the programmer. An exception is said to be “thrown” from the point where it occurred and is said to be “caught” at the point to which control is transferred. Typically, exceptions are thrown directly by operation of the JVM. Exceptions, however, can also be thrown by class library and/or other operations. For example, methods can also throw exceptions explicitly by using “throw” statements.

In an exemplary embodiment, when an exception is thrown during execution of a method, control is transferred from the lower level module 220 to the upper level module 210 to locate the nearest code that handles the exception. For example, when an exception is thrown, the upper level module 210 may search for an exception handler in the method being executed. If an exception handler is found in the method being executed, the upper level module 210 would branch to the appropriate exception handling code in the method and transfer control to the lower level module 220 to execute the exception handling code. When the exception handling code has been executed, the lower level module 220 would transfer control to the upper level module 210. The upper level module 210 then may determine whether the execution of the method should resume. If so, control would be transferred to the lower level module 220 to resume execution of the method.

If no exception handler is found in the method being executed, the upper level module 210 may look into other methods for exception handling until a suitable exception handler is found. If no suitable exception handler is found, the upper level module 210 may terminate the thread in which the exception was thrown.

The situation described above is merely exemplary. Those skilled in the art will appreciate that other exception handling techniques may be implemented according to the requirements of a particular operational implementation.

4. Maintaining Multi-Threading Functions

The JVM typically can support multiple threads at substantially the same time. These threads may independently execute code that operates on values and objects residing in a shared main memory. Threads may be supported by having multiple hardware processors, by time-slicing a hardware processor, by time-slicing multiple hardware processors, or by other configurations.

Generally, multi-threading requires mechanisms for synchronizing concurrent activities among the threads and for handling asynchronous events. In an exemplary embodiment, the upper level module 210 may provide one or more of these mechanisms.

a. Managing Synchronization

The upper level module 210 may also provide synchronization support by managing so-called “monitors.” Monitors are used as a mechanism for allowing one thread at a time to execute a region of code. The behavior of monitors may be explained in terms of locks. Generally, there is a lock (or monitor) associated with each object. To access a shared object, a thread usually first obtains a lock for the object (i.e., enters a monitor). When the thread is done with the object, the lock is unlocked (i.e., exits a monitor). By unlocking, the object held by the thread is written back to the main memory.

For example, if an object (and/or variable) is assigned to one or more threads, access to that object may be enclosed in a “synchronized” method. In this example, when executing a synchronized method, the upper level module 210 may automatically perform a lock operation when the method is invoked. After the lock operation has been successfully completed, the bye code instructions within the synchronized method's body are executed via the lower level module 220. When the execution of the synchronized method's body is completed, control would be transferred to the upper level module 210 which may automatically perform an unlock operation.

Of course, the situation described above is merely exemplary. Those skilled in the art will appreciate that other synchronization techniques may be implemented according to the requirements of a particular operational implementation.

b. Responding to Asynchronous Events

The upper level module 210 may also respond to asynchronous events. For example, an exception may be thrown when an asynchronous event (e.g., an internal error) occurs. In this example, control would be transferred to the upper level module 210 for handling the exception. Exception handling techniques are as described above in Section III.A.3. Other asynchronous events include, without limitation, timer expirations and/or user inputs via an input device such as a keyboard 136 and/or a pointing device 138 (see FIG. 1).

Those skilled in the art will appreciate that other techniques for responding to asynchronous events may be implemented according to the requirements of a particular operational implementation.

B. Exemplary Function for the Lower Level Module

In an exemplary embodiment, the lower level module 220 executes byte code instructions of an invoked method. During execution of a method, if the lower level module 220 encounters a reason to transfer control to the upper level module 210, the lower level module 220 may generate an instruction (or flag, indicia, etc.) that indicates: (1) the reason for transferring control to the upper level module 210; and (2) the continuation address to the lower level module 220, if necessary.

For example, if a second method is invoked during the execution of a first method, the lower level module 220 would transfer control to the upper level module 210 and include an instruction indicating the reason for transferring control (i.e., to invoke the second method). Additionally, if the first method has not yet fully executed, the lower level module 220 would also indicate a continuation address to the first method in the instruction transferred to the upper level module 210. For example, when the second method has been invoked and fully executed, the upper level module 210 would use the continuation address to return to the lower level module 220 at the location where the execution of the first method is to resume.

In one implementation, the lower level module 220 may also execute native machine code of an invoked method. In this implementation, if the invoked method has already been compiled into native machine code (e.g., via a JIT), the lower level module 220 would execute the native machine code until there is a reason to transfer control to the upper level module 210. For example, the lower level module 220 may execute a first method until the first method calls a second method. In this example, the second method may not have been compiled into native machine code; thus, the interpreter 200 has to interpret and execute the second method during runtime. The upper level module 210 may invoke the second method, and transfer control to the lower level module 220 to execute the second method. The lower level module 220 interprets and executes byte code instructions of the second method until there is a reason to transfer control to the upper level module 210. For instance, when the second method has been fully executed, the lower level module 220 would transfer control to the upper level module 210. In this case, the upper level module 210 would determine the continuation address to the first method and transfer control to the lower level module 220, if necessary, to continue the execution of the native machine code of the first method.

Alternatively, other modules implemented on the native hardware may be used for executing native machine code. In this implementation, an interface between such a module and the multi-module interpreter 200 may be employed to allow transfer of control among them.

IV. An Exemplary Flow of Control in an Exemplary Multi-Module Interpreter

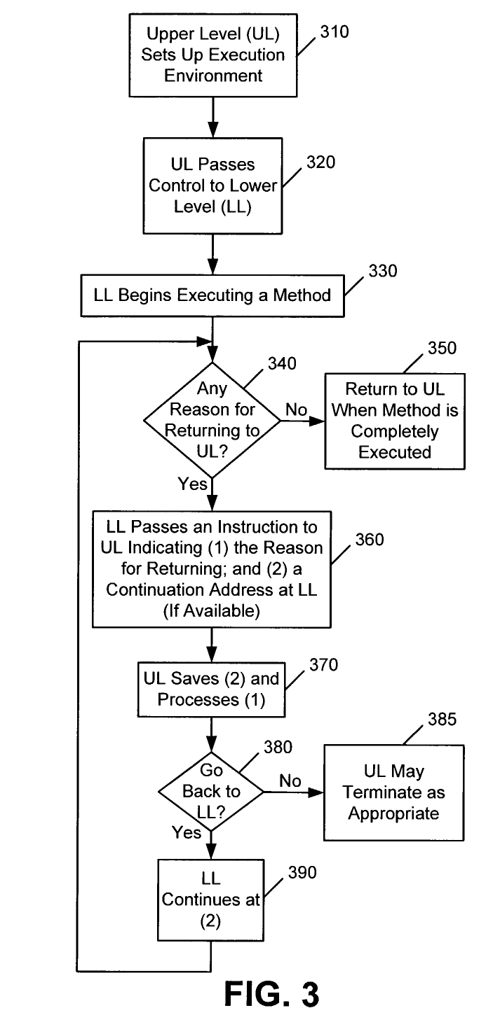

FIG. 3 illustrates an exemplary flow of control among the multiple modules of a multi-module interpreter. The multi-module interpreter 200 has an upper level module 210 and a lower level module 220. At step 310, the upper level module 210 sets up an execution environment for an invoked method. For example, the upper level module 210 may initialize objects and variables into memory space for use by the invoked method. At step 320, the upper level module 210 transfers control to the lower level module 220 for execution of the method. During execution of the method (i.e., execute the byte code instructions and/or native machine code within the method) (step 330), the lower level module 220 continues until it encounters a reason for transferring control to the upper level module 210 (step 340). For example, the lower level module 220 may wish to transfer control to the upper level module 210 when one or more of the following occurs, including, without limitation: (1) an invocation of another method; (2) a return from the method being executed; (3) an initialization of a class; (4) an exception; (5) a synchronization function; (6) an asynchronous event; and/or other functions. If there is no reason to transfer control to the upper level module 210 during execution of the method, the lower level module continues executing the method and transfers control to the upper level module 210 upon completion of execution of the method (step 350). In an exemplary embodiment, when the process ends at step 350, the control is transferred to the upper level module 210.

Referring back to step 340, if a reason for transferring control to the upper level module 210 is encountered, then the lower level module 220 may generate an instruction that indicates (1) the reason for transferring control to the upper level module 210 and/or (2) a continuation address at the lower level module 220 to resume the execution of the method (if necessary) (step 360). After receiving the instruction from the lower level module 220, the upper level module 210 may store the continuation address, if available, in memory and perform functions in accordance with the reason specified in the instruction (step 370). At step 380, after completing such specified functions, the upper level module 210 determines whether to transfer control to the lower level module 220. If the upper level module 210 decides to transfer control to the lower level module 220 (e.g., if a continuation address is provided), control is transferred to the lower level module 220. The lower level module 220 then may resume execution of the method at the continuation address. Referring back to step 380, if the upper level module 210 determines to not transfer control to the lower level (e.g., no continuation address and/or for other reasons), control remains at the upper level module 210. In one implementation, the upper level module 210 may terminate a thread (where the method is being executed or has been executed) as appropriate (step 385). For example, the upper level module 210 may terminate a thread that threw an exception for which no suitable exception handler was found (see Section III.A.3 above.

At step 390, if control is transferred to the lower level module 220, the lower level module 220 resumes execution of the method (at the continuation address) until another reason for transferring control to the upper level module 210 is encountered (see step 340).

Of course, the flow of control described above is merely exemplary. Those skilled in the art will appreciate that other processes that implement other flows of control may also be used accordingly to the requirements of a particular implementation.

V. Miscellaneous Aspects

The modules disclosed herein are typically implemented as software installed on a computer platform, but may also be implemented in hardware or a combination of software and hardware. The software could be stored and accessed from a variety of computer-readable media including, without limitation, a hard disk, a CD, RAM (of all types), and still other electronic, magnetic and/or optical media known to those skilled in the art.

Further, the upper level module and the lower level module may each be implemented as a single module or multiple modules that are logically coupled to each other. For example, the upper level module may be implemented as multiple modules each responsible for providing one or more types of execution functions.

The multi-module interpreter can be implemented to provide execution functions in a manner such that execution functions do not necessarily have to be encoded into compiled native machine code. Of course, use of a multi-module interpreter 200 does not strictly exclude encoding of the execution functions into compiled native machine code, but merely eliminate the necessity of such encoding.

The multi-module interpreter can also be implemented in a manner such that it does not require a recursive control structure. For example, if during execution of a first method, the first method calls a second method, which in turn calls a third method, and so forth, a typically recursive control structure would call a conventional interpreter for each method to be invoked. In contrast, each call to a wholly conventional interpreter would require memory resources to be set aside for that interpreter. Thus, one could end up with numerous interpreters running at substantially the same time and consuming an unacceptably large amount of memory resources.

In addition, in many situations, the multi-module interpreter may be implemented relatively simply compared to a typical recursive control structure. Instead of calling itself repeatedly, the multi-module interpreter uses multiple modules that cooperate with each other via a simple interface to transfer control among the modules. It is to be understood that the multiple modules in the multi-module interpreter may recursively call each other for transferring control between them. Of course, use of a multi-module interpreter does not strictly exclude the use of a recursive control structure, but merely eliminate the necessity of using the recursive control structure.

VI. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims.

What is claimed is:

1. A multi-module interpreter, comprising:
(a) a first module configured to provide execution functions for executing a computer method obtained via an input interface;
(b) a second module, logically coupled to said first module, configured to:
(i) execute said computer method until a control transfer event occurs;
(ii) generate an instruction indicating said control transfer event;
(iii) transfer control and said instruction to said first module for processing said control transfer event;
(c) an interface configured to facilitate transfer of control between said first and second modules; and
(d) an output interface configured to output a result of said executed computer method.

2. The multi-module interpreter of claim 1 where said instruction further includes a continuation address to said second module.

3. The multi-module interpreter of claim 2 where said first module is further configured to:
(i) determine whether to transfer control to said second module when said control transfer event has been processed; and
(ii) transfer control to said second module based on said continuation address.

4. The multi-module interpreter of claim 1 where said second module is configured to execute native machine code of said computer method.

5. The multi-module interpreter of claim 1 further comprising:
(e) a third module, logically coupled to said first module via said interface in said (c), configured to:
(i) execute native machine code of said computer method until a control transfer event occurs; and
(ii) generate an instruction indicating said control transfer event; and
(iii) transfer control and said instruction to said first module for processing said control transfer event.

6. The multi-module interpreter of claim 1 where said execution functions include setting up an execution environment.

7. The multi-module interpreter of claim 1 where said execution functions include invoking another method called by said computer method.

8. The multi-module interpreter of claim 1 where said execution functions include initializing a class called by said computer method.

9. The multi-module interpreter of claim 1 where said execution functions include handling an exception of said computer method.

10. The multi-module interpreter of claim 9 where said first module is further configured to:
(i) search for exception handling code in said computer method; and
(ii) transfer control to said second module for executing said exception handling code.

11. The multi-module interpreter of claim 9 where said first module is further configured to:
(i) search for exception handling code in another computer method different than said computer method;
(ii) invoke said another computer method; and
(iii) transfer control to said second module for executing said another computer method.

12. The multi-module interpreter of claim 9 where said first module is further configured to:
(i) search for exception handling code; and
(ii) terminate said computer method if no exception handling code is found in said (i).

13. The multi-module interpreter of claim 1 where said execution functions include providing multi-threading functions.

14. The multi-module interpreter of claim 13 where said multi-threading functions include providing synchronization functions among multiple threads.

15. The multi-module interpreter of claim 14 where said first module is further configured to:
(i) perform a lock operation on a shared object upon invocation of a synchronized computer method;
(ii) transfer control to said second module for executing said synchronized computer method; and
(iii) perform an unlock operation on said shared object upon completion of said executing in said (ii).

16. The multi-module interpreter of claim 13 where said multi-threading functions include responding to asynchronous events.

17. A method for executing a computer method, comprising:
(a) obtaining a computer method via an input interface;
(b) executing said computer method in a second module until a control transfer event occurs;
(c) generating an instruction in said second module indicating said control transfer event;
(d) transferring control and said instruction to a first module via an interface;
(e) processing said control transfer event in said first module; and
(f) outputting a result of said executed computer method via an output interface.

18. The method of claim 17 where said instruction further includes a continuation address to said second module.

19. The method of claim 18 further comprises:
(x) transferring control to said second module based on said continuation address via said interface; and
(y) resuming execution of said computer method based on said continuation address.

20. The method of claim 17 where said computer method includes native machine code instructions.

21. The method of claim 17 where said control transfer event includes a call to another computer method.

22. The method of claim 17 where said control transfer event includes a call to initialize a class.

23. The method of claim 17 where said control transfer event includes an occurrence of an exception.

24. The method of claim 23 further comprising:
(x) searching for exception handling code in said computer method; and
(y) transferring control to said second module for executing said exception handling code.

25. The method of claim 23 further comprising:
(x) searching for exception handling code in another computer method different than said computer method;
(y) invoking said another computer method; and
(z) transferring control to said second module for executing said another computer method.

26. The method of claim 23 further comprising:
(x) searching for exception handling code; and
(y) terminating said computer method if no exception handling code is found in said (x).

27. The method of claim 17 where said control transfer event includes an occurrence of an asynchronous event.

28. A multi-module interpreter, comprising:
(a) means for providing execution functions for executing a computer method obtained via an input interface;
(b) means for:
(i) executing said computer method until a control transfer event occurs;
(ii) generating an instruction indicating said control transfer event;
(iii) transferring control and said instruction to said means for providing execution functions for processing said control transfer event;
(c) means for facilitating transfer of control between said first and second modules; and
(d) means for outputting a result of said executed computer method.

29. An apparatus for executing a computer method, comprising:
(a) means for executing a computer method in a second module until a control transfer event occurs;
(b) means for generating an instruction indicating said control transfer event;
(c) means for transferring control and said instruction to a first module via an interface;
(d) means for processing said control transfer event in said first module; and
(e) means for outputting a result of said executed computer method.

30. A computer readable medium for executing a computer method, comprising logic instructions that, if executed:
(a) execute a computer method in a second module until:
(i) a control transfer event occurs;
(b) generate an instruction in said second module indicating said control transfer event;
(c) transfer control and said instruction to a first module via an interface; and
(d) process said control transfer event in said first module.

31. The computer readable medium of claim 30 where said instruction further includes a continuation address to said second module.

32. The computer readable medium of claim 31 further comprises logic instructions that, if executed:
(x) transfer control to said second module based on said continuation address via said interface; and
(y) resume execution of said computer method based on said continuation address.

33. The computer readable medium of claim 30 where said computer method includes native machine code instructions.
